(19) United States
(12) Patent Application Publication
(10) Pub. No.: US 2007/0117041 A1
(43) Pub. Date: May 24, 2007

(54) Photosensitive coating for enhancing a contrast of a photolithographic exposure

(76) Inventors: Christoph Noelscher, Nuernberg (DE); Klaus Elian, Bubenreuth (DE)

Correspondence Address: SLATER & MATSIL LLP, 17950 PRESTON ROAD, SUITE 1000, DALLAS, TX, 75252, US

(21) Appl. No.: 11/285,786

(22) Filed: Nov. 22, 2005

(51) Int. Cl. G03C 1/00

(52) U.S. Cl. 430/270.1

(57) ABSTRACT

In a preferred embodiment, a photosensitive coating material for use as a contrast enhancing layer (CEL) disposed at the bottom of a resist film includes a base polymer, which has no acid cleavable groups for being insoluble with respect to a developer, wherein the developer is designed to remove exposed portions of the resist film. The CEL material further has a solvent for facilitating deposition of the photosensitive coating material upon a surface of a substrate. In one embodiment, the CEL further includes a photolytic acid generator, which is arranged to release an acid under exposure, said acid being arranged to diffuse into the adjacent resist deposited upon the CEL in order to enhance an acid concentration formed in exposed portions of the resist. In another embodiment, the CEL includes an alkaline additive, which is arranged to be photodecomposable to a non-alkaline, neutral compound under exposure. This alkaline additive is arranged to diffuse into the adjacent resist deposited on top of the CEL, in order to reduce an acid concentration formed in un- or less exposed portions of the resist.

### TECHNICAL FIELD

The invention relates to a photosensitive coating for enhancing a contrast of a photolithographic exposure of a resist formed on a substrate. The invention further relates to multilayer resists and/or antireflective coatings.

### BACKGROUND

In the field of semiconductor manufacturing integrated circuits are formed by exposing semiconductor wafers layer by layer, each with a pattern formed on respective masks of a dedicated set. The wafers are thereby covered with a photosensitive resist, which is coated onto the layer to be exposed. With the ongoing decrease of feature sizes, lithographic enhancement techniques are employed in order to increase the resolution and depth of focus with respect to an exposure. These techniques relate to improvements in the optical systems (exposure apparatus), types of masks (phase shift masks, trimming masks, etc.) or the resists.

One phenomenon that often occurs, when features are printed onto a wafer having a width near the resolution limit of the optical projection system, is the formation of side lobes near a respective main feature in the resist on the substrate. These side lobes may form as intensity side maxima primarily near the top surface of a resist on a wafer, because the intensity decreases vertically with depth and the side maxima will not be able exceed a threshold level for an effective exposure in larger depths.

However, side lobes may also occur as dark artifacts (intensity minima) at the bottom surface of a resist, i.e., adjacent to an underlying layer or coating on the wafer. For example, the projection of semi-dense dark lines, which are formed as absorbing layers on an otherwise bright mask, into a positive resist deposited on a wafer may lead to the formation of less exposed areas within a region that is intended to be effectively exposed. This is particularly valid if the projection is carried out in defocus.

The same problem occurs with subresolution assist features (SRAF) added to the pattern within the spaces, which are intended to improve the process window by means of an increased contrast and steepened resist profiles. At the bottom of the resist, the intensity may become insufficient to stimulate the photolytic acid generators in the resist to release enough acid during exposure. This may result in resist residues remaining at the bottom surface after development and thus in erroneous etch results with respect to the underlying layer that is presently to be structured.

One approach to this problem is a descumming process by means of reactive ion etching using oxygen as a reactive agent. Herein, a defined amount of developed resist including the residues is taken from the overall wafer surface, which may lead to an effective removal of the residues upon the underlying layer. However, the resist thickness is disadvantageously reduced and the quality of the resist profile, in particular the resist edges, may degrade.

A further approach is to utilize features of a bottom antireflective coating (BARC). A BARC is often used to improve the exposure characteristics of a resist, i.e., the reduction of standing waves within the resist due to reflections of light at the bottom surface. As ammonia emerging from an underlying layer containing nitrogen may poison the BARC, the footing of the resist or portions thereof upon the BARC may considerably increase. For the purpose of reducing this footing, an acid is added to the BARC. There is a side effect that this acid may diffuse into the adjacent resist during a post exposure bake step, thereby increasing the overall solubility of the resist during a subsequent development step. Applied to the presently discussed problem, the occurrence of dark side lobes or printed SRAFs is implicitly reduced due to the increased amount of acid in a bottom region of the resist.

Examples of bottom antireflective coatings (BARC) are described in Meador, et al., “Improved Crosslinkable Polymeric Binders for 193-nm Bottom Antireflective Coatings (BARCs)”, Advances in Resist Technology and Processing XVIII, Proceedings of SPIE Vol. 4345 (2001), pages 846-854; and Devadoss, et al., “Investigation of BARC-Resist Interfacial Interactions”, Optical Microlithography XVI, Proceedings of SPIE Vol. 5040 (2003), pages 912-922.

A still further approach is provided by establishing developable BARCs. Their goal is to avoid the disadvantages of the homogeneous dry etch process for removing the resist residues by making the BARC soluble with respect to a developer, for example the developer that is applied to the resist. Accordingly, exposed regions of the resist are removed simultaneously with those portions of the BARC that border the exposed regions as the developer solution advances through the resist—BARC interface. However, undercutting effects may occur due to the isotropic development behavior, when portions beneath unexposed regions of the resist are dissolved by the developer. Further, the development contrast of those BARCs may be limited, such that a mere minimum line width of, e.g., 180 nm may be applicable in combination with such BARCs.

Examples of developable BARCs are described in Cox, et al., “Developer Soluble Organic BARCs for KrF Lithography”, Advances in Resist Technology and Processing, Proceedings of SPIE Vol. 5039 (2003), pages 878-882; and Krishnamurty, et al., “Novel Spin Bowl Compatible, Wet Developable Bottom Anti-Reflective Coating for I-Line Applications”, Advances in Resist Technology and Processing, Proceedings of SPIE, Vol. 5039 (2003), pages 883-890.

Still a further approach deals with photosensitive or photodefinable BARCs. A photolytic acid generator (PAG) is added to the BARC in order to release an acid under exposure conditions, and the BARC-resin has acid cleavable groups. This type of developable BARC then comprises features of a typical chemically amplified resist (CAR). In particular, the development profile becomes anisotropic, because only exposed regions within the BARC are soluble with respect to a developer applied to the resist.

Photosensitive or photodefinable BARCs are described, e.g., in Owe-Yang, et al., “Application of Photosensitive BARC and KrF Resist on Implant Layers”, Advances in Resist Technology and Processing, Proceedings of SPIE Vol. 5376 (2004), pages 452-459; and Guerrero, et al., “A New Generation of Bottom Anti-Reflective Coatings (BARCs): Photodefinable BARCs”, Advances in Resist Technology and Processing, Proceedings of SPIE Vol. 5039 (2003), pages 129-134.

### SUMMARY OF THE INVENTION

One aspect of the invention improves the quality of lithographic projection, in particular of dense periodic or semi-dense lines from a mask into a resist deposited onto a wafer. A further aspect improves the contrast achievable during an exposure, a subsequent bake and a development in a resist. A further aspect reduces the occurrences of dark side lobes within intentionally clear areas (i.e., to be exposed areas) in bottom regions of a resist. A further aspect improves the resolution and the depth of focus with regard to photolithographic exposure.

In accordance with embodiments of the invention, there is provided a photosensitive coating material for enhancing a contrast of a photolithographic exposure of a resist film to be deposited upon a layer, which is formed from the photosensitive coating material, including a base polymer, which includes no acid cleavable groups for being insoluble with respect to a developer, which is designed to remove exposed portions of said resist film; a solvent for facilitating deposition of the photosensitive coating material upon a surface of a substrate; and a photolytic acid generator, which is arranged to release an acid under exposure with optical light, UV- or X-ray radiation, electrons, charged particles, ion projection lithography, the acid arranged to diffuse into the adjacent resist deposited upon the layer formed from the photosensitive coating material in order to enhance an acid concentration formed in exposed portions of the resist.

In accordance with further embodiments of the invention, there is provided a photosensitive coating material for enhancing a contrast of a photolithographic exposure of a resist film to be deposited upon a layer, which is formed from the photosensitive coating material, including a base polymer, which includes no acid cleavable groups for being insoluble with respect to a developer, which is designed to remove exposed portions of the resist film; a solvent for facilitating deposition of the photosensitive coating material upon a surface of a substrate; and an alkaline additive, which is arranged being photodecomposable to a non-alkaline, neutral compound under exposure with optical light, UV- or X-ray radiation, electrons, charged particles, ion projection lithography; and to diffuse into the adjacent resist deposited upon the layer, which is formed from the photosensitive coating material, in order to reduce an acid concentration formed in un- or less exposed portions of the resist.

Further aspects relate to the provision of a multilayer coating disposed on a substrate prior to photolithographic exposure, including a contrast enhancing layer (CEL), which is composed of a photosensitive coating material as detailed above, having a photodecomposable alkaline additive and/or a photolytic acid generator, and having a base polymer, which has no acid cleavable groups, the contrast enhancing layer being deposited upon the substrate; and at least one photosensitive resist film, which is disposed upon the contrast enhancing layer, such that the contrast enhancing layer (CEL) contacts the photosensitive resist film at the resist bottom surface.

The resist film may include a further base polymer having an acid sensitive group, and a photolytic acid generator for generating an acid under exposure with optical light, UV- or X-ray radiation, electrons, charged particles, ion projection lithography. The released acid is arranged to cleave the acid sensitive group from the remainder polymer for altering the polarity of this first base polymer. A selective removal of altered polymer portions with respect to non-altered portions is thus provided, e.g., by means of a developer solution.

According to a further aspect, a substrate is provided having a surface the includes the multilayer according to the previously-mentioned aspect. Methods of manufacturing the photosensitive coating material and of exposing a semiconductor wafer using this material are also provided in the appended claims.

The photosensitive coating material as described according to aspects and embodiments of the invention is also referred to throughout this document as a “bottom contrast enhancement layer” (BCEL), or simply as a photosensitive contrast enhancing layer (CEL), as it functions to enhance the contrast in and after an exposure of the resist deposited on top of the BCEL. In particular, the photosensitive coating (BCEL) is deposited below the resist film and alters (improves) the signature (acid concentration profile) of an exposure in a bottom region of the resist.

As opposed to known contrast enhancing layers, which are generally deposited on top of a resist, the “BCEL” as proposed herein has the feature of being insoluble with respect to a developer solvent, which is designed to remove de-blocked polymers of a resist due to an exposure. The base polymers of the BCEL, however, cannot be de-blocked as they do not have acid cleavable groups.

It is noted that solvents exist in which the photosensitive coating material ingredients such as the base polymer, the photolytic acid generator and/or the photodecomposable alkaline additive are soluble in order to facilitate deposition (e.g., spin-on) upon a wafer or photomask surface. However, these solvents are incompatible with those solvents used for the development step, which is performed with respect to the resist.

Accordingly, although the present photosensitive coating material encompasses photoactive components such as photolytic acid generators and/or photodecomposable alkaline additives, these components have substantially no influence on the characteristics of this bottom layer.

Rather, either the photolytic acid generators and/or photodecomposable alkaline additives, or their photoreactive products, the released acids and/or decomposed non-alkaline compounds, respectively, are arranged to diffuse into the adjacent resist film on top of the BCEL. More precisely, these are arranged to diffuse into a bottom region of the resist in order to increase the acid concentration in exposed portions of the resist, or to decrease an alkaline concentration therein as compared with un- or less exposed regions. As a result, the chemical contrast between exposed and unexposed regions particularly in the bottom region of the resist is enhanced.

With regard to the term “alkaline” as used herein, it is understood that material simply having a larger pkₐ-value than the acids within the resist is also included herein, as it is similarly suited to achieve the effects of the invention as described below.

With regard to the term “substrate,” it is understood herein that the substrate may include a base body of a specific material such as silicon, glass or quartz, and further one or more layers deposited on top of the surface of this body. In some of the embodiments described later herein, the body may also explicitly be referred to as the substrate.

It is preferred that both layers are formed adjacent to each other, i.e., they are in direct contact with each other. Further, dark side lobes or dark SRAFs printing in the resist frequently develop near the bottom surface of the resist film due to absorption of light within the resist. Additionally, the diffusion length of the acid and alkaline molecules is too short to completely penetrate the resist film. Consequently, the use of the photosensitive contrast-enhancing coating as a bottom coat is preferred. In this case, the diffusing molecules may easily reach the (bottom) region, where printing of dark side lobes or dark SRAFs may often arise.

The photosensitive coating comprises a photoactive component. This component serves to reduce or neutralize the concentration of alkaline additives under exposure, i.e., within exposed regions. Two aspects, which may also be combined, relate to embodiments of the photoactive component. In one embodiment, the photoactive component is a photolytic acid generator; in another embodiment, the photoactive component is provided by the alkaline additive itself, which is then photodecomposable.

The outdiffusion of the acids released in the case of the photolytic acid generators primarily occurs during a post-exposure bake step. The photosensitive coating contacts the resist film, which causes outdiffusion of the released acids during this bake step within exposed areas from the BCEL into the resist film. Consequently, the acid concentration therein is increased, which is not the case in un- or less exposed areas. As a result, the chemical contrast between exposed and un- or less exposed is enhanced.

In this embodiment, which relates to the aspect of photolytic acid generators, an optional refinement may be accomplished by adding alkaline additives to the photosensitive coating. The alkaline additives, also called quenchers, diffuse out of the coating into the adjacent resist and lead to a reduction or neutralization of possible acid concentrations in un- or less exposed regions of the resist, while there is only a moderate reduction in exposed areas, due to the simultaneously diffusing acids.

In any case, the outdiffusion of alkaline additives leads to a neutralization, or quenching, of acids generated in the resist film during an exposure. Due to the finite diffusion length, the quenching occurs in a region near the contact surface between the resist film and the photosensitive coating, i.e., in a bottom region of the resist film.

It is also possible to add photodecomposable alkaline additives to the coating, which comprises photolytic acid generators. Herein, the chemical contrast being achieved between exposed and un- or less exposed regions, is strongest.

In the alternate embodiment relating to photodecomposable alkaline additives a reduction of alkaline concentration in exposed regions of the coating film is accomplished. One specific, but not limiting example of a photodecomposable alkaline additive relates to triphenylsulfonium acetate. As a result of adding a photodecomposable base, alkaline outdiffusion into the adjacent resist film above is inhibited, or at least reduced in these areas.

Accordingly, one effect of preferred embodiments of the invention is that the chemical contrast in acid concentrations between exposed and unexposed regions in the resist is enhanced. Another effect is that the level of acid concentration in a bottom region of the resist is increased with respect to a top surface region. As the optical contrast correlates with the contrast in acid concentration, the invention works as if the optical contrast had been enhanced and as if the strong absorption towards the resist bottom is decreased.

In a further aspect the BCEL is arranged to function as a bottom anti-reflective layer (BARC). Therein, the refractive indices of the BCEL are adapted to range between that of the overlying resist and that of the underlying material layer, such that the reflection at the surface boundaries is reduced, just as in conventional antireflection techniques, e.g., with a refractive index n close to that of the resist (for example: n_{(BCEL)}=n₍ᵣₑₛᵢₛₜ₎±0.2) and an absorption coefficient ranging from, e.g., 0.5 to 2.0 μm⁻¹.

With regard to the base polymer and the solvents, the photosensitive coating is not limited to the specific embodiments presented herein and a person skilled in the art will readily recognize that similar materials having the substantially same effect can be exploited as well.

For example, the photosensitive coating material to be disposed as a contrast enhancing layer may, according to an embodiment, include a base polymer, which is based on an acryl or vinyl polymer platform. Examples are polyethers, polyesters, polyurethanes, dye attached polysaccharides, polymerblends with additional Styrene-monomers, etc. The acryl or vinyl polymers may be attached with light absorbing dyes. They may further be arranged to be crosslinkable.

Alternately, novolaks, cresol-novolaks, polyhydroxystyrene, among others, may be employed for the base polymer of the photosensitive coating material and the BCEL, according to embodiments.

Crosslinkers may, according to an embodiment, be added, which are of the melamine or urea type. Also, secondary or tertiary alcohols are possible.

As a solvent, common resist solvents, such as for example, methoxypropylacetate, ethyllactate, cyclohexanone, cyclopentanone, g-butyrolactone, propylene glycol monomethyl ether acetate (PGMEA), propylene glycol monomethyl ether (PGME), etc., may be used according to embodiments.

Further embodiments relate to the aspect of a photolytic acid generator (PAG). The PAG may comprise triphenylsulphonium or diphenyliodonium salts of strong sulphonic acids, which are also called crivello salts. For example, triphenylsulphonium-nonafluorbutanesulphonate or diphenyliodonium-p-toluolsulphonate may be used as the photolytic acid generator.

In an alternate embodiment, N,O-sulfonic acid esters, o-nitrobenzylic acids, diazonaphtoquinonesulfonates (DNQ), AsF₆ or SbF₆ may be used with regard to the PAG. Therein the N,O-sulfonic acid esters may be, for example, phtalimidotosylates or related sulphonic nitrogen bound esters of phthalimides.

In case a quencher or alkaline additive is added to the PAG, which is not photodecomposable, the alkaline additive may be associated with a first pKa value, which is larger than a second pKa-value provided by the adjacent resist. The alkaline additive may be an anorganic base, or alternatively, an organic base such as an amine. For example, the alkaline additive may be provided by trialkylamines or trialcohol amines. More precisely, the alkaline additive may be represented by trioctylamines or triethanolamines. The alkaline additive may further be tetramethylammonium acetate, etc. It goes without saying that a person skilled in the art and carrying out the prescriptions as enclosed herein may also consider other suitable photodecomposable alkaline materials.

It is noted, that—with regard to tetramethylammonium acetate—the term “alkaline additive,” which is to be considered throughout this document as a relative quantity with respect to acids generally contained in the adjacent resist, may also include weak acids, e.g., carbonic acids (e.g., carboxylate being added), acetic acids, salicylic acids, etc.

A further important aspect of the photosensitive coating relates to a combination of a thermo acid generator with a photodecomposable alkaline additive within the same coating. The thermo acid generator is arranged to release an acid, when its temperature is increased beyond a threshold level, particularly during a bake step. For example, the thermo acid generator may be a benzylthiolanium or benzyldithiolanium compound of sulfonic acids. In a particular embodiment, the thermo acid generator is one of benzylthiolanium hexafluorpropanesulfonate or benzyldithiolanium hexafluorpropanesulfonate.

Further advantageous aspects and embodiments are evident from the appended claims.

### BRIEF DESCRIPTION OF THE DRAWINGS

Other aspects and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs.

FIG. 1 shows an embodiment of a photosensitive coating serving as a contrast-enhancing layer applied as a BARC beneath a resist film on a substrate;

FIGS. 2-5 show a sequence of cross-sectional profiles through the photosensitive bi-layer coating shown in FIG. 1 with respect to different method steps according to embodiments of the invention;

FIGS. 6-8 show with regard to one embodiment (bottom coating with PAG) the resulting profiles of the base or acid concentration as a function of the x-coordinate corresponding to the cross-sectional profiles shown in FIGS. 2-4;

FIGS. 9-11 show with regard to another embodiment (bottom coating with photodecomposable alkaline additive) the resulting profiles of the base or acid concentration as a function of the x-coordinate corresponding to the cross-sectional profiles shown in FIGS. 2-4; and

FIGS. 12-14 show third and fourth embodiments relating to coatings with PAG, and photodecomposable alkaline additive, respectively, which are applied to critical lines-and-spaces patterns with conventional assist printing.

The following list of reference symbols can be used in conjunction with the figures:

| | |
|---|---|
| 8 | semiconductor wafer |
| 10 | substrate |
| 12 | layer on substrate, to be structured |
| | by lithographic patterning |
| 14 | resist film |
| 16 | photosensitive coating, bottom |
| | contrast enhancing layer (BCEL) |
| 22 | exposed region in BCEL |
| 24 | unexposed region in BCEL |
| 32 | exposed region in resist film |
| 34 | unexposed region in resist film |
| 40 | exposure light beam |
| 50 | etch step |
| 60, 61 | diffusion |

### DETAILED DESCRIPTION OF ILLUSTRATIVE EMBODIMENTS

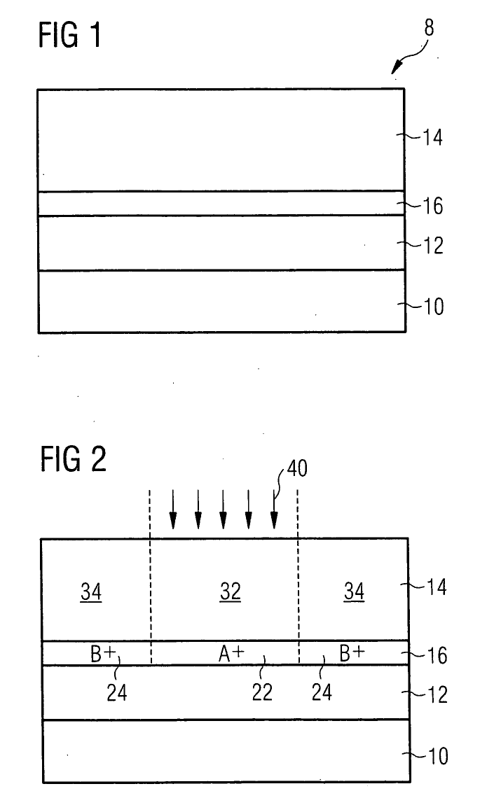

FIG. 1 shows an embodiment of a photosensitive coating serving as a bottom contrast-enhancing layer (BCEL) formed on a semiconductor wafer 8. A layer 12 of a material to be structured (etched) such as an oxide, a nitride, a metal, poly silicon, etc., is deposited on a substrate 10, which may be monocrystalline silicon. The cross-section depicted in FIG. 1 is rather schematical, and it is clear that multiple structure layers forming a stack with a topography not shown in the figures may be embodied similarly.

A photosensitive coating 16 is applied upon the layer 12. In this embodiment, the photosensitive coating 16 is composed of a dye attached and crosslinkable vinyl or acryl polymer, e.g., of a polyether platform, a PGMEA solvent, a photodecomposable alkaline additive such as triphenylsulphonium acetate, and a thermo acid generator such as benzylthiolanium hexafluorpropansulphonate or benzyldithiolanium hexafluorpropansulphonate. The chemical constitution of the thermo acid generator may be provided as:

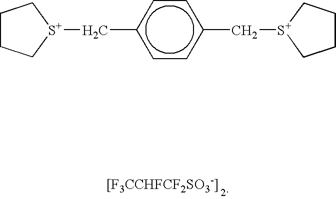

A resist film 14 is spun on the bottom layer 16. The resist film 14 is formed of any conventionally known type of resist material, which may be novolak-based, chemically amplified, vinyl or acryl based, crosslinked, etc. The resist comprises—besides a base polymer—a photolytic acid generator.

The base polymer of the photosensitive coating 16 is characterized in that it does not comprise an acid cleavable group - in contrast to the base polymer of the resist film 14. It is further noted that the photosensitive coating 16 and the resist film 14 have a direct contact surface in order to facilitate diffusion of molecules between both layers 14, 16.

The resist material includes a base polymer, such that it may not dissolve the bottom coating 16 relating to the contrast enhancing layer. The bottom coating 16 has a thickness in the range 30-800 nm, while the resist film 14 has a thickness of 50 to 400 nm. A pre-bake step is performed to dry the still semi-liquid resist material.

FIGS. 2-5 show a sequence of process steps applied to the wafer 8 shown in FIG. 1. First, as shown in FIG. 2, an exposure of a resist area 32 is performed in a lithographic projection apparatus using light having a wavelength of, e.g., 193 nm. The pattern being transferred from a photomask may relate to a dense and periodic contact hole pattern or alternatively isolated spaces each surrounded by an extended opaque or semitransparent layer on the mask.

As the resist film 14 is sufficiently transparent, an area 22 of the underlying bottom photosensitive coating 16 (i.e., the BCEL) is also exposed with light. The exposure leads to a conversion of the slightly alkaline acetate ions of the triphenylsulphonium acetate into an acetic acid. The acidity of the latter compound is denoted as “non-alkaline and neutral” throughout this document, and it is clear that these expressions merely illustrate a relative quality. It is important that the basicity of the initially alkaline additive is lost or at least reduced due to photodecomposition in exposed areas 22 of the bottom coating 16. Un- or less exposed areas 24 of the bottom coating 16, however, reveal an unaltered concentration of alkaline additives, indicated as “B+” in FIG. 2.

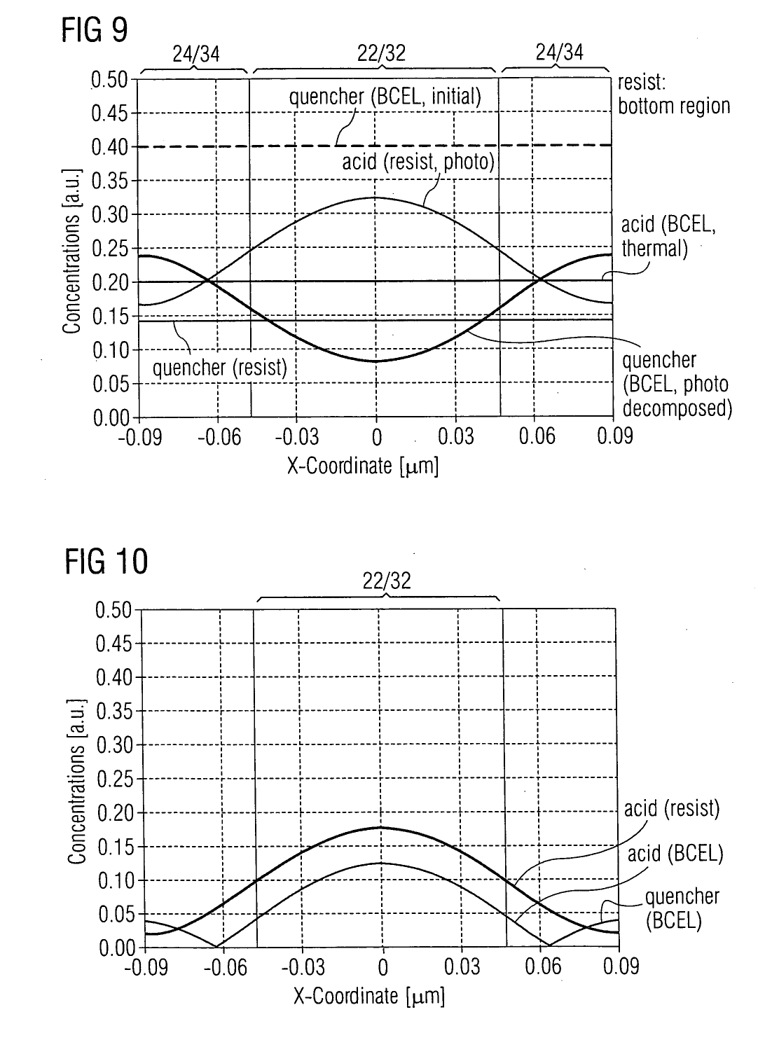

FIGS. 9-11 show a sequence of schematic diagrams of acid and alkaline concentrations versus x-coordinate across an exposed area 22, 32 in the resist and BCEL, respectively. This exposed area corresponds to a clear line having a (critical) width of, e.g., 90 nm. Further exposure conditions are: lines-and-spaces pattern formed on the photomask, with each line and space having a width of 90 nm; the numerical aperture is 0.85; annular illumination is exploited with σᵢₙₙₑᵣ=0.55 and σᵢₙₙₑᵣ=0.85; the thickness of resist plus bottom coating is chosen to 360 nm; the bottom coating further has BARC properties (refractive index adapted to optical properties of resist); and best focus and best dose are selected as exposure parameters of the respective projection tool in this embodiment.

FIGS. 9-11 correspond to the embodiment illustrated with respect to FIGS. 1-5. FIG. 9 indicates the situation after exposure. Accordingly, an acid concentration within the resist film 14 is increased, and the alkaline, or quencher concentration within the BCEL coating 16 is decreased in exposed areas 22, 32.

Next a post exposure bake step (PEB) is performed at temperatures in a range of 50° C.-170° C. In a preferred embodiment, a range of 100° C.-150° C. is considered. The thermo acid generator releases an acid under these temperatures. As the temperature is applied to the whole wafer, the acid concentration starts to increase throughout the coating 16. This situation is depicted in FIG. 10, wherein an adverse effect of neutralization of acids with respect to quenchers each within one layer is assumed according to the simplified model shown here.

The use of a thermo acid generator as a precursor for the acid offers a particular advantage because the post exposure bake is necessary and cannot be circumvented. However, it is found that most photolytic acid generators or free acids will be thermally decomposed at the respective temperatures. This may result in a reduced shelf life of a bottom coating. On the contrary, the thermo acid generator of the present embodiment advantageously exploits the features of the PEB bake step.

Consequently, in exposed areas 22 of the bottom coating 16 arises an excess acid concentration due to the thermally generated acids and due the photogenerated acids by means of photodecomposition. This excess acidity is indicated by “A+” in FIG. 2.

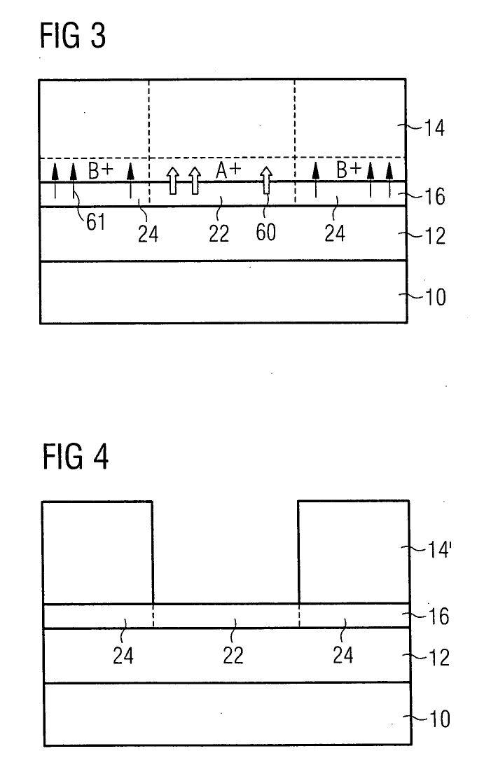

Simultaneously with the thermal generation of the acids, a diffusion of acid and alkaline molecules is initiated within the bake step as shown in FIG. 3. As a result of this diffusion, acids diffuse into exposed areas 32 of the resist film 14 within a bottom region. Similarly, alkaline additives remaining in un- or less exposed areas 24 of coating 16 diffuse into respective areas 34 of the resist film. In either case, the local concentration of acids or bases is enhanced. Further, the contrast in basicity or acidity between areas 32, 34 increases near the bottom surface of resist film 14.

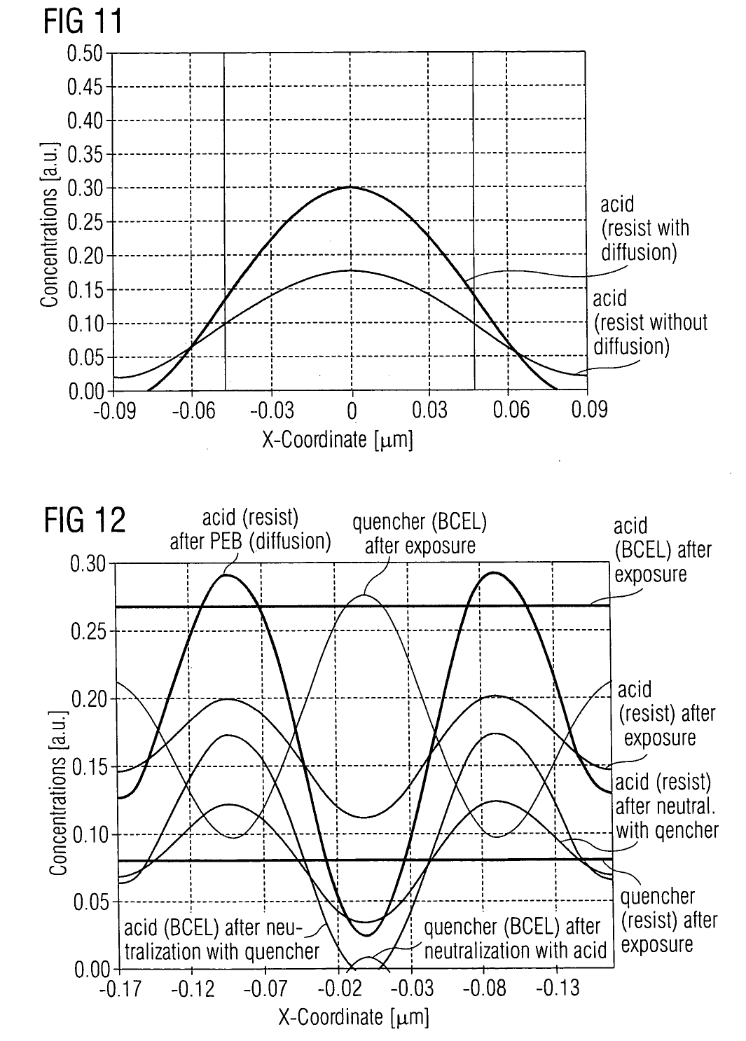

This contrast is also indicated in FIG. 11, which corresponds to the situation shown in FIG. 3. Therein, the effect of diffusion is compared with a case, where no diffusion is allowed.

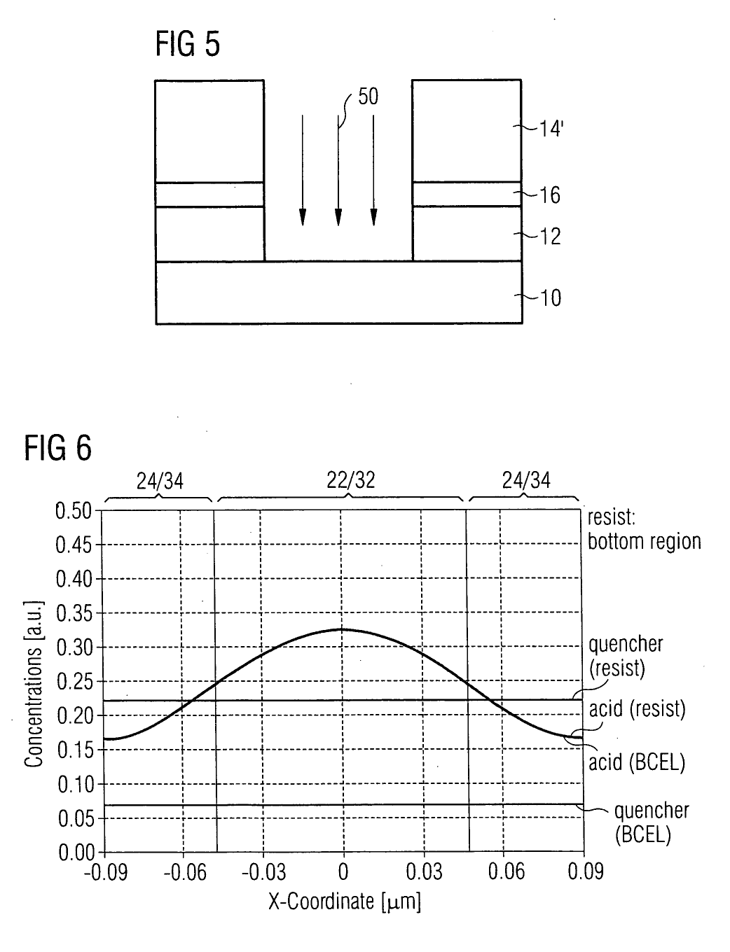

One effect is that dark side lobes occurring within this bottom surface region (indicated by a dotted line in the figures) within exposed area 34 are diminished since the acid concentration is increased beyond a threshold representing an effective removal in a following development step, which is indicated in FIG. 4. The development may, e.g., be carried out with a conventional TMAH developer. Note that the bottom coating 16 is not affected by the development, because no acid sensitive groups can be cleaved by the acids in bottom coating 16. FIG. 5 shows the result of a further etch step performed on the bottom coating and the underlying material layer 12 using the developed resist film 14′ as an etch mask.

Another embodiment is illustrated with regard to FIGS. 6-8. The exposure settings are similar to those as detailed above. The photosensitive coating 16 herein includes a photolytic acid generator instead of a photodecomposable alkaline additive, or instead of the thermo acid generator respectively, employed in the first embodiment. Nevertheless, a photoindependent quencher is also added to the photosensitive coating 16.

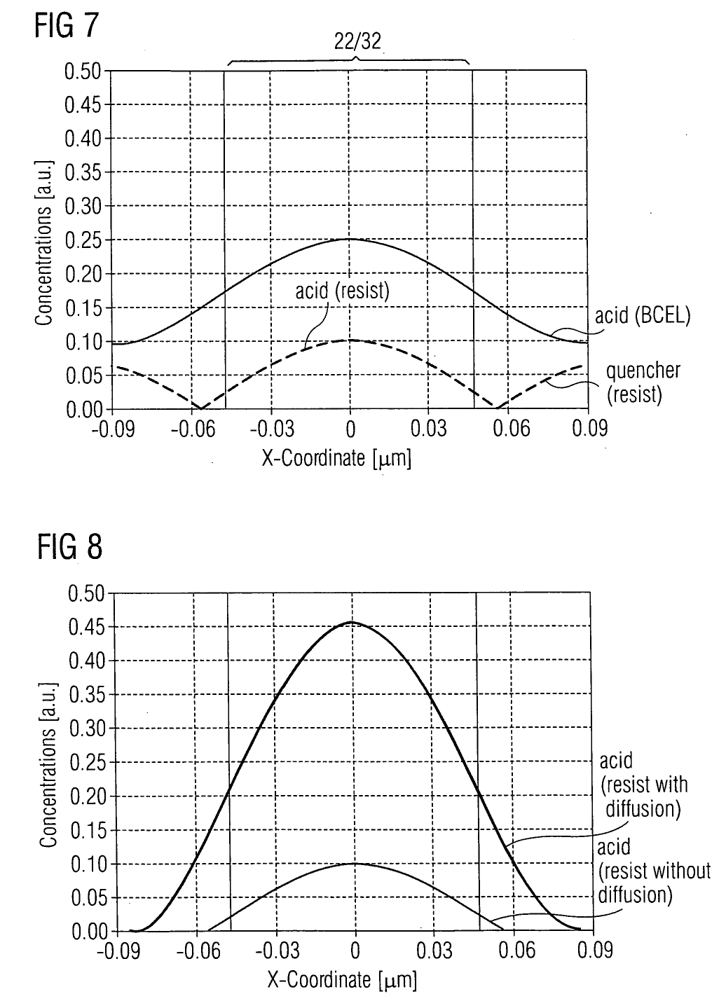

FIG. 6 shows the profiles of acid or alkaline concentration along the x-coordinate similar to FIG. 9, after exposure. Due to the exposure, the PAG has released acids within exposure area 32 at the bottom region of the resist, and within area 22 of the BCEL photosensitive coating 16. FIG. 7 shows the situation after adverse neutralization of acids and quenchers within the layers 14 and 16, respectively, in a first step of the post exposure bake. Simultaneously, the bake step drives a net diffusion of acids into the resist, which is shown in FIG. 8. The acid concentration in the resist bottom region that would occur without diffusion from the BCEL is indicated for comparison.

It has to be noted that the individual diffusion lengths and initial concentration of the acids and the quenchers may be differ such that multiple vertical concentration profiles may be realized.

As a result of the net diffusion, a moderate amount of quencher concentration B+ in the unexposed region 34 in the resist film may develop near the bottom surface of the resist film 14. On the contrary, a considerable acid concentration A+ in the exposed region 32 of the resist film 14 is achieved (see FIG. 3, which is also representative with respect to this embodiment).

FIG. 12 shows the results of an embodiment applied to a challenging exposure condition that would conventionally lead to the printing of subresolution assist features (SRAF) on the wafer, if present on the mask. These features are, however, not intended to be printed on the wafer, but to improve the process window of the projection step. The pattern to be transferred onto the wafer is a dense lines-and-spaces array. The target line has a width of 100 nm. The space has a width of 240 nm. The SRAF-structures have a width of 40 nm and are placed in the center of the spaces between each two lines. The photosensitive coating has similar features to that of the first embodiment, i.e., a photodecomposable alkaline additive is implemented along with thermo acid generator.

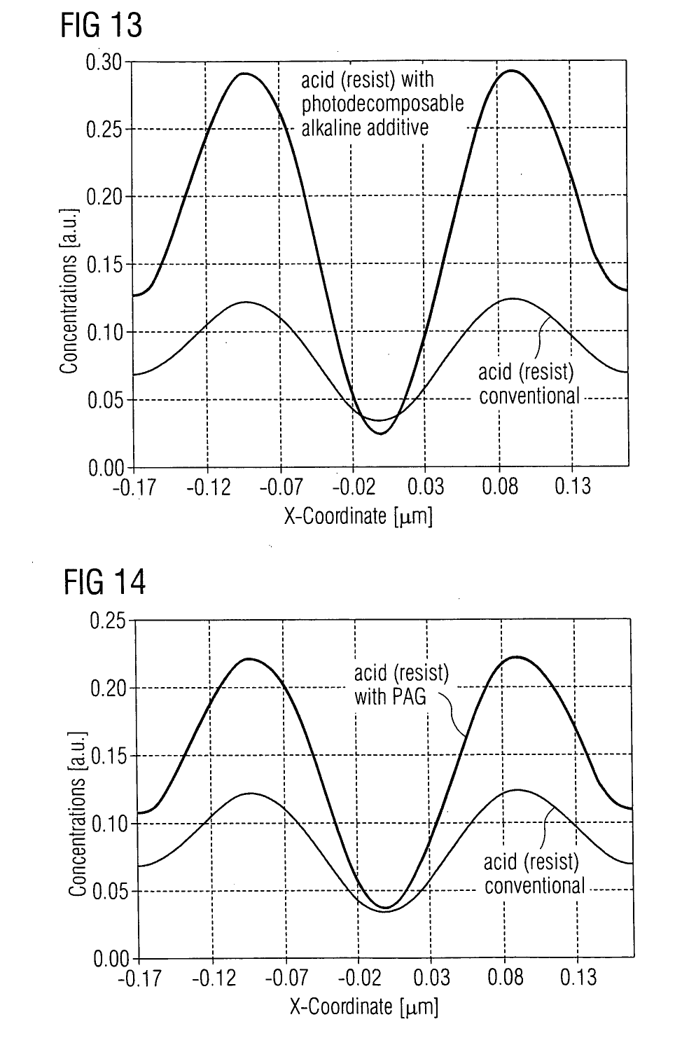

As can be seen from the dashed curve (acid concentration of resist after PEB), a significant improvement in chemical contrast is achieved in this embodiment. A comparison with the conventional case is indicated in FIG. 13. The acid contrast is enhanced from 27% to 68% under the simplified assumptions of this embodiment. The contrast enhancement reaches a factor of 2.5 in this embodiment.

FIG. 14 shows a further embodiment, wherein the photosensitive coating 16 is provided with a PAG (for example a crivello salt, such as triphenylsulphonium salts, of sulphonic acids), and a photo-independent quencher (for example trioctylamine, etc.). The contrast in this embodiment still amounts to 50%, representing a contrast enhancement factor of almost 2.0 with respect to prior art.

What is claimed is:

1. A photosensitive coating, to be deposited underneath a photoresist film, for enhancing a contrast of a photolithographic exposure of the photoresist- film, comprising:
a base polymer, which comprises no acid cleavable groups for being insoluble with respect to a developer, which is designed to remove exposed portions of said resist film;
a solvent for facilitating deposition of the photosensitive coating upon a surface of a substrate; and
a photolytic acid generator, which is arranged to release an acid under exposure with optical light, UV- or X-ray radiation, electrons, charged particles, ion projection lithography, said acid being arranged to diffuse into an adjacent resist deposited upon the layer formed from the photosensitive coating in order to enhance an acid concentration formed in exposed portions of the resist.

2. The photosensitive coating according to claim 1, further comprising:
an alkaline additive, which is suited to diffuse into the adjacent resist deposited upon the layer formed from the photosensitive coating for reducing or neutralizing an acid concentration formed in unexposed portions therein, and/or to reduce or neutralize a concentration of the acid in unexposed portions of the layer formed from the photosensitive coating.

3. The photosensitive coating according to claim 1, wherein the base polymer is an acryl or vinyl polymer.

4. The photosensitive coating according to claim 3, wherein the base polymer is attached with a light absorbing dye.

5. The photosensitive coating according to claim 3, wherein the base polymer is selected from the group consisting of polyether, polyester, polyurethane, dye attached polysaccharide and polymerblend added with styrene-monomers.

6. The photosensitive coating according to claim 1, wherein the base polymer is selected from the group consisting of novolaks, cresol-novolaks and polyhydroxystyrene.

7. The photosensitive coating according to claim 6, wherein the base polymer is attached with a light absorbing dye.

8. The photosensitive coating according to claim 1, further comprising a crosslinker.

9. The photosensitive coating according to claim 8, wherein the crosslinker is of a melamine type or of a urea type.

10. The photosensitive coating according to claim 8, wherein the crosslinker is a secondary or tertiary alcohol.

11. The photosensitive coating according to claim 1, wherein the photolytic acid generator comprises a material selected from the group consisting of crivello salts, N,O-sulfonic acid esters, o-nitrobenzylic acids, diazonaphtoquinonesulfonates (DNQ), AsF₆ and SbF₆.

12. The photosensitive coating according to claim 11, wherein the crivello salts are selected from the group consisting of triphenylsulfonium salts of sulfonic acids and diphenyliodonium salts of sulfonic acids.

13. The photosensitive coating according to claim 11, wherein the N,O-sulfonic acid esters are phtalimidotosylates or related sulphonic nitrogen bound esters of Phthalimides.

14. The photosensitive coating according to claim 2, wherein the alkaline additive is associated with a first pKa value, which is larger than a second pKa-value provided with the adjacent resist.

15. The photosensitive coating according to claim 2, wherein the alkaline additive is an anorganic base.

16. The photosensitive coating according to claim 2, wherein the alkaline additive is an organic amine.

17. The photosensitive coating according to claim 16, wherein the alkaline additive is at least one of Trialkylamine or Trialcohol amines.

18. The photosensitive coating according to claim 17, wherein the alkaline additive is a Trioctylamine or a Triethanolamine.

19. The photosensitive coating according to claim 2, wherein the alkaline additive is tetramethylammonium acetate.

20. The photosensitive coating according to claim 1, wherein the solvent is selected from the group consisting of propylene glycol monomethyl ether (PGMEA), ethyllactate, cyclohexanone and g-butyrolactone.

21. A photosensitive coating, to be deposited underneath a photoresist film, for enhancing a contrast of a photolithographic exposure of the photoresist film, comprising:
a base polymer, which comprises no acid cleavable groups for being insoluble with respect to a developer, which is designed to remove exposed portions of said resist film;
a solvent for facilitating deposition of the photosensitive coating upon a surface of a substrate; and
an alkaline additive, which is arranged to photodecompose to a non-alkaline, neutral compound under exposure with optical light, UV- or X-ray radiation, electrons, charged particles, ion projection lithography, and to diffuse into the adjacent resist deposited upon the layer, which is formed from the photosensitive coating, in order to reduce an acid concentration formed in un- or less exposed portions of the resist.

22. The photosensitive coating according to claim 21, wherein the photodecomposable alkaline additive is a chemical compound, which has a pK-value, that increases by means of exposure with optical light, UV- or X-ray radiation, electrons, charged particles, ion projection lithography.

23. The photosensitive coating according to claim 21, wherein the photodecomposable alkaline additive comprises triphenylsulfonium acetate.

24. The photosensitive coating according to claim 21, further comprising an acid generator.

25. The photosensitive coating according to claim 24, wherein the acid generator is a photolytic acid generator.

26. The photosensitive coating according to claim 25, wherein the photolytic acid generator is arranged to release an acid under exposure with optical light, UV- or X-ray radiation, electrons, charged particles, ion projection lithography, said acid being arranged to diffuse into an adjacent resist deposited upon the layer formed from the photosensitive coating in order to enhance an acid concentration formed in exposed portions of the resist.

27. The photosensitive coating according to claim 24, wherein the acid generator is a thermo acid generator, which is arranged to release an acid when its temperature is increased beyond a threshold level, particularly during a bake step.

28. The photosensitive coating according to claim 27, wherein the thermo acid generator is a benzylthiolanium or benzyldithiolanium compound of sulfonic acids.

29. The photosensitive coating according to claim 27, wherein the thermo acid generator is selected from the group consisting of benzylthiolanium hexafluorpropanesulfonate and benzyldithiolanium hexafluorpropanesulfonate.

30. The photosensitive coating according to claim 21, wherein the base polymer is an acryl or vinyl polymer.

31. The photosensitive coating according to claim 30, wherein the base polymer is attached with a light absorbing dye.

32. The photosensitive coating according to claim 30, wherein the base polymer is selected from the group consisting of polyether, polyester, polyurethane, dye attached polysaccharide and polymerblend added with styrene-monomers.

33. The photosensitive coating according to claim 21, wherein the base polymer is selected from the group consisting of novolaks, cresol-novolaks and polyhydroxystyrene.

34. The photosensitive coating according to claim 33, wherein the base polymer is attached with a light absorbing dye.

35. The photosensitive coating according to claim 21, further comprising a crosslinker.

36. The photosensitive coating according to claim 35, wherein the crosslinker is of a melamine type or of a urea type.

37. The photosensitive coating according to claim 35, wherein the crosslinker is a secondary or tertiary alcohol.

38. The photosensitive coating according to claim 21, wherein the solvent is selected from the group consisting of propylene glycol monomethyl ether (PGMEA), ethyllactate, cyclohexanone and g-butyrolactone.

39. A multilayer coating disposed on a substrate prior to photolithographic exposure, comprising:
a contrast enhancing layer (CEL) disposed on said substrate, said contrast enhancing layer comprising
a base polymer, which comprises no acid cleavable groups for being insoluble with respect to a developer, which is designed to remove exposed portions of said resist film;
a solvent for facilitating deposition of the photosensitive coating upon a surface of a substrate; and
a photolytic acid generator, which is arranged to release an acid under exposure with optical light, UV- or X-ray radiation, electrons, charged particles, ion projection lithography, said acid being arranged to diffuse into an adjacent resist deposited upon the layer formed from the photosensitive coating in order to enhance an acid concentration formed in exposed portions of the resist; and
at least one photosensitive resist film, which is disposed upon said contrast enhancing layer, such that said contrast enhancing layer (CEL) contacts said photosensitive resist film at the resist bottom surface.

40. The multilayer coating according to claim 39, wherein said contrast enhancing layer (CEL) is a bottom anti-reflective coating (BARC).

41. The multilayer coating according to claim 39, wherein the substrate is selected from the group consisting of a photomask and a semiconductor wafer.

42. The multilayer coating according to claim 41, further comprising a material layer disposed between the substrate and the contrast enhancing layer.

43. A multilayer coating disposed on a substrate prior to photolithographic exposure, comprising:
a contrast enhancing layer (CEL) disposed on said substrate, said contrast enhancing layer comprising:
a base polymer, which comprises no acid cleavable groups for being insoluble with respect to a developer, which is designed to remove exposed portions of said resist film;
a solvent for facilitating deposition of the photosensitive coating upon a surface of a substrate; and
an alkaline additive, which is arranged to photodecompose to a non-alkaline, neutral compound under exposure with optical light, UV- or X-ray radiation, electrons, charged particles, ion projection lithography, and to diffuse into an adjacent resist deposited upon the layer, which is formed from the photosensitive coating, in order to reduce an acid concentration formed in un- or less exposed portions of the resist; and
at least one photosensitive resist film, which is disposed upon said contrast enhancing layer, such that said contrast enhancing layer (CEL) contacts said photosensitive resist film at the resist bottom surface.

44. The multilayer coating according to claim 43, wherein said contrast enhancing layer (CEL) is a bottom anti-reflective coating (BARC).

45. The multilayer coating according to claim 43, wherein the substrate is selected from the group consisting of a photomask and a semiconductor wafer.

46. The multilayer coating according to claim 44, further comprising a material layer disposed between the substrate and the contrast-enhancing layer.

47. A method of manufacturing a photosensitive coating for enhancing the contrast of a photolithographic exposure of a photosensitive resist film, wherein the photosensitive coating is to be disposed upon a substrate surface at the bottom of the photosensitive resist film, comprising:
providing a photosensitive coating comprising:
a base polymer, which comprises no acid cleavable groups for being insoluble with respect to a developer, which is designed to remove exposed portions of said resist film;
a solvent for facilitating deposition of the photosensitive coating upon a surface of a substrate;
a photolytic acid generator, which is arranged to release an acid under exposure with optical light, UV- or X-ray radiation, electrons, charged particles, ion projection lithography, said acid being arranged to diffuse into the adjacent resist deposited upon the layer formed from the photosensitive coating material in order to enhance an acid concentration formed in exposed portions of the resist; and
dissolving the base polymer, the photolytic acid generator and the alkaline additive in the solvent for facilitating deposition of the photosensitive coating upon a surface of the substrate to form a film thereupon.

48. The method of manufacturing a photosensitive coating for enhancing the contrast of a photolithographic exposure of a photosensitive resist film, wherein the photosensitive coating is to be disposed upon a substrate surface at the bottom of the photosensitive resist film, comprising:
providing a photosensitive coating comprising:
a base polymer, which comprises no acid cleavable groups for being insoluble with respect to a developer, which is designed to remove exposed portions of said resist film;
a solvent for facilitating deposition of the photosensitive coating upon a surface of a substrate;
an alkaline additive, which is arranged to photodecompose to a non-alkaline, neutral compound under exposure with optical light, UV- or X-ray radiation, electrons, charged particles, ion projection lithography, and to diffuse into an adjacent resist deposited upon the layer, which is formed from the photosensitive coating, in order to reduce an acid concentration formed in un- or less exposed portions of the resist; and
dissolving the base polymer and the photodecomposable alkaline additive in the solvent for facilitating deposition of the photosensitive coating upon a surface of the substrate to form a film thereupon.

49. The method of exposing a semiconductor wafer, comprising:
applying a photosensitive coating material to the surface of said semiconductor substrate to form a contrast enhancing layer (CEL) with respect to a resist, said contrast enhancing layer comprising:
a base polymer, which comprises no acid cleavable groups;
an alkaline additive; and
a photolytic acid generator;
applying a photosensitive resist on top of the contrast enhancing layer to form a resist film thereupon;
exposing said resist film and the underlying contrast enhancing layer within a portion with optical light, UV- or X-ray radiation, electrons, charged particles, ion projection lithography, wherein a concentration of acids in exposed portions of the contrast enhancing layer is increased due to acids released by the first photolytic acid generators;
diffusing released acids out of exposed portions of the contrast enhancing layer into a bottom region of the adjacent resist film to increase an acid concentration in exposed portions of the resist film;
diffusing alkaline additives out of un- or less exposed portions of the contrast enhancing layer into the bottom region of the resist film to reduce or neutralize the acid concentration in un- or less exposed portions of the resist film and to increase the contrast in acid concentration between exposed and unexposed portions therein; and
applying a developer solution to the resist film to remove either exposed or unexposed portions thereof.

50. The method of exposing a semiconductor wafer, comprising:
applying a photosensitive coating material to the surface of said semiconductor substrate to form a contrast enhancing layer (CEL) with respect to a resist, said contrast enhancing layer comprising:
a base polymer, which comprises no acid cleavable groups,
a photodecomposable alkaline additive; and
a thermo acid generator;
applying a photosensitive resist on top of the contrast enhancing layer to form a resist film thereupon;
applying a thermal bake step in order to release acids in the contrast enhancing layer (CEL) by means of the thermo acid generator;
exposing said resist film and the underlying contrast enhancing layer within a portion with optical light, UV- or X-ray radiation, electrons, charged particles, ion projection lithography, wherein a concentration of alkaline additives in exposed portions of the contrast enhancing layer is reduced due to decomposition into neutral compounds;
diffusing the thermally released acids out of exposed portions of the contrast enhancing layer into a bottom region of the adjacent resist film to increase an acid concentration in exposed portions of the resist film; and
diffusing alkaline additives remaining in un- or less exposed portions out of the contrast enhancing layer into the bottom region of the resist film to reduce or neutralize the acid concentration in un- or less exposed portions of the resist film and to increase the contrast in acid concentration between exposed and unexposed portions therein; and
applying a developer solution to the resist film to remove either exposed or unexposed portions thereof.

51. The method according to claim 50, wherein diffusing the alkaline additive and the acids respectively into the resist film is performed by means of a post exposure bake step.

52. The method according to claim 51, further comprising etching the contrast enhancing layer (CEL) using the resist film as an etch mask after either exposed or unexposed portions have been removed.
